(19) United States
(12) Patent Application Publication
(10) Pub. No.: US 2026/0292237 A1
(43) Pub. Date: Sep. 24, 2026

(54) METHODS FOR TEMPORAL MOTION VECTOR PREDICTION

(71) Applicant: Alibaba (China) Co., Ltd., Hangzhou (CN)

(72) Inventors: Ru-ling LIAO, Sunnyvale, CA (US); Jie CHEN, Beijing (CN); Yan YE, San Diego, CA (US); Xinwei LI, Beijing (CN)

(21) Appl. No.: 19/555,211

(22) Filed: Mar. 3, 2026

Related U.S. Application Data
(60) Provisional application No. 63/774,822, filed on Mar. 20, 2025.

(51) Int. Cl. H04N 19/52; H04N 19/105; H04N 19/159; H04N 19/176; H04N 19/55; H04N 19/593

(52) U.S. Cl. CPC H04N 19/52; H04N 19/105; H04N 19/159; H04N 19/176; H04N 19/55; H04N 19/593

(57) ABSTRACT

The present disclosure provides computer-implemented methods for video processing. The method includes receiving a video sequence; and encoding the video sequence by determining whether a collocated block in a collocated picture of a current block has a block vector (BV); in response to the collocated block having the BV, determining the BV; determining a motion vector for Temporal Motion Vector Prediction (TMVP) for the current block based on the BV of the collocated block; and determining a reference index of the TMVP to be a reference index of the collocated picture.

### CROSS-REFERENCE TO RELATED APPLICATIONS

This disclosure claims the benefits of priority to U.S. Provisional Application No. 63/774,822, filed on Mar. 20, 2025, which is incorporated herein by reference in its entirety.

### TECHNICAL FIELD

The present disclosure generally relates to video processing, and more particularly, to methods for temporal motion vector prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method for encoding a video sequence. The method includes receiving a video sequence; and encoding the video sequence by determining whether a collocated block in a collocated picture of a current block has a block vector (BV); in response to the collocated block having the BV, determining the BV; determining a motion vector for Temporal Motion Vector Prediction (TMVP) for the current block based on the BV of the collocated block; and determining a reference index of the TMVP to be a reference index of the collocated picture.

Embodiments of the present disclosure provide method for decoding a bitstream. The method includes receiving a bitstream; and decoding the bitstream to generate a video sequence. The decoding includes determining whether a collocated block in a collocated picture of a current block has a block vector (BV); in response to the collocated block having the BV, determining the BV; determining a motion vector for Temporal Motion Vector Prediction (TMVP) for the current block based on the BV of the collocated block; and determining a reference index of the TMVP to be a reference index of the collocated picture.

Embodiments of the present disclosure provide a method for transmitting a bitstream. The method includes receiving a video sequence; encoding the video sequence by determining whether a collocated block in a collocated picture of a current block has a block vector (BV); in response to the collocated block having the BV, determining the BV; determining a motion vector for Temporal Motion Vector Prediction (TMVP) for the current block based on the BV of the collocated block; and determining a reference index of the TMVP to be a reference index of the collocated picture; and transmitting a bitstream that is generated based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 illustrates exemplary motion vector scaling for temporal merge candidate, according to some embodiments of the present disclosure.

FIG. 6 illustrates exemplary positions for collocated blocks, according to some embodiments of the present disclosure.

FIG. 7 is a flowchart of an exemplary method for deriving a motion vector for Temporal Motion Vector Prediction (TMVP) from a block vector (BV), according to some embodiments of the present disclosure.

FIG. 8A is a flowchart of an exemplary sub-step of a method for deriving a motion vector for TMVP from BV, according to some embodiments of the present disclosure.

FIG. 8B illustrates an exemplary diagram consistent with the method in FIG. 8A, according to some embodiments of the present disclosure.

FIG. 9A is a flowchart of another exemplary sub-step of a method for deriving a motion vector for TMVP from BV, according to some embodiments of the present disclosure.

FIG. 9B illustrates an exemplary diagram consistent with the method in FIG. 9A, according to some embodiments of the present disclosure.

FIG. 10A is a flowchart of another exemplary sub-step of a method for deriving a motion vector for TMVP from BV, according to some embodiments of the present disclosure.

FIG. 10B illustrates an exemplary diagram consistent with the method in FIG. 10A, according to some embodiments of the present disclosure.

FIG. 11 is a flowchart of another exemplary sub-steps of a method for deriving a motion vector for TMVP from BV, according to some embodiments of the present disclosure.

FIG. 12 is a flowchart of an exemplary method for constituting a TMVP candidate list, according to some embodiments of the present disclosure.

FIG. 13 illustrates temporal motion that needed to be stored, according to the prior art.

FIG. 14 illustrates exemplary temporal motion that needed to be stored, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC’s goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG- 1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

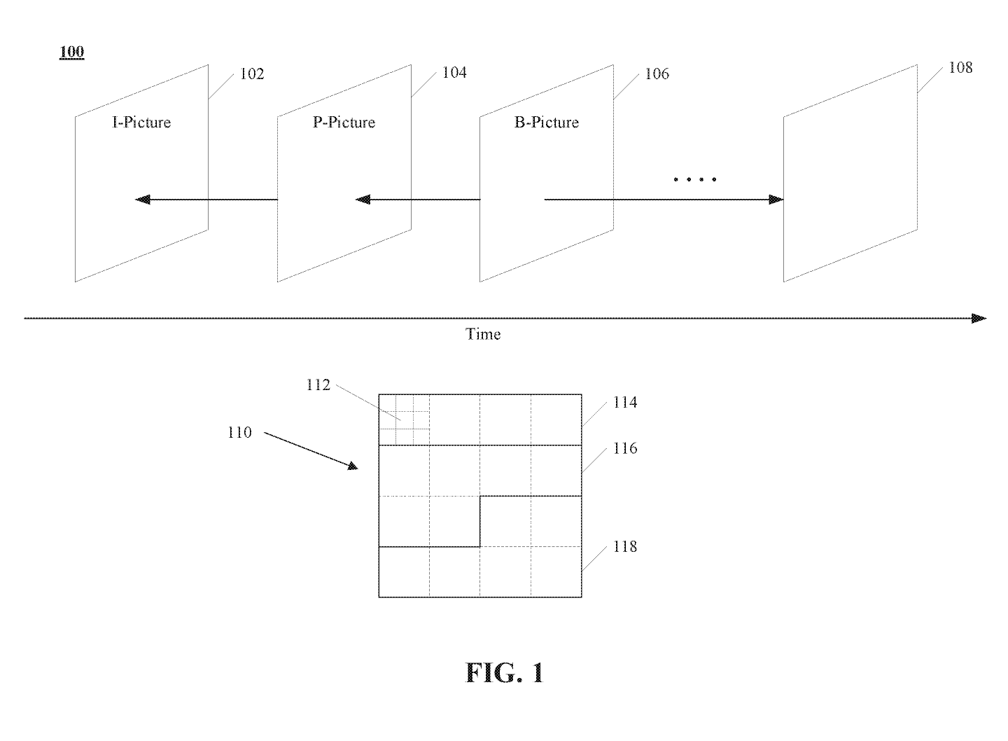

FIG. 1 illustrates structures of an exemplary video sequence 100, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) may not be immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

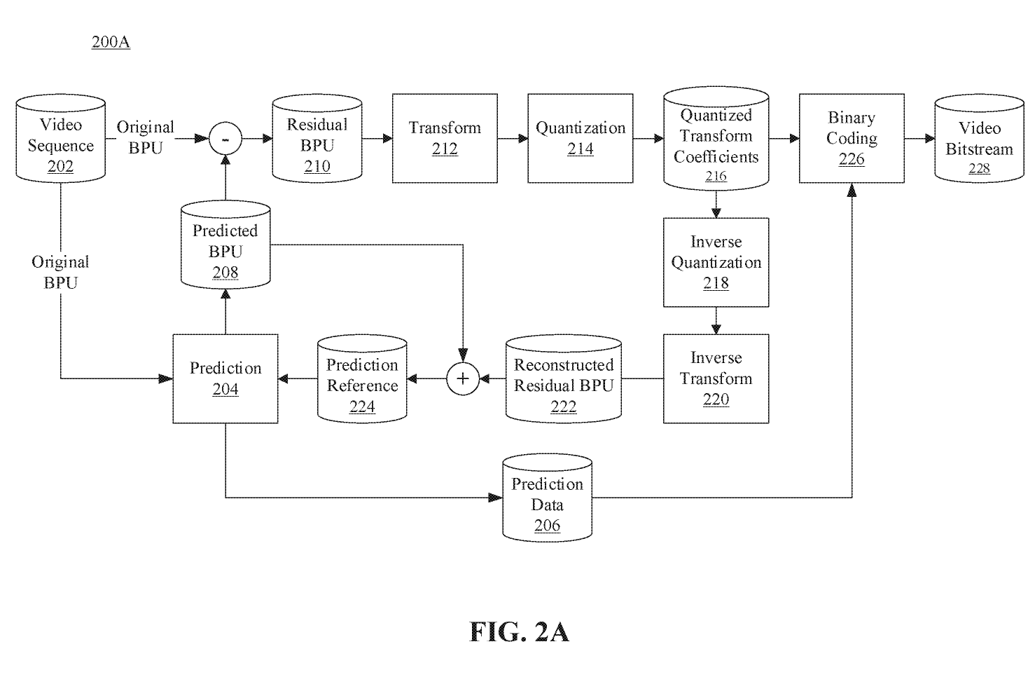

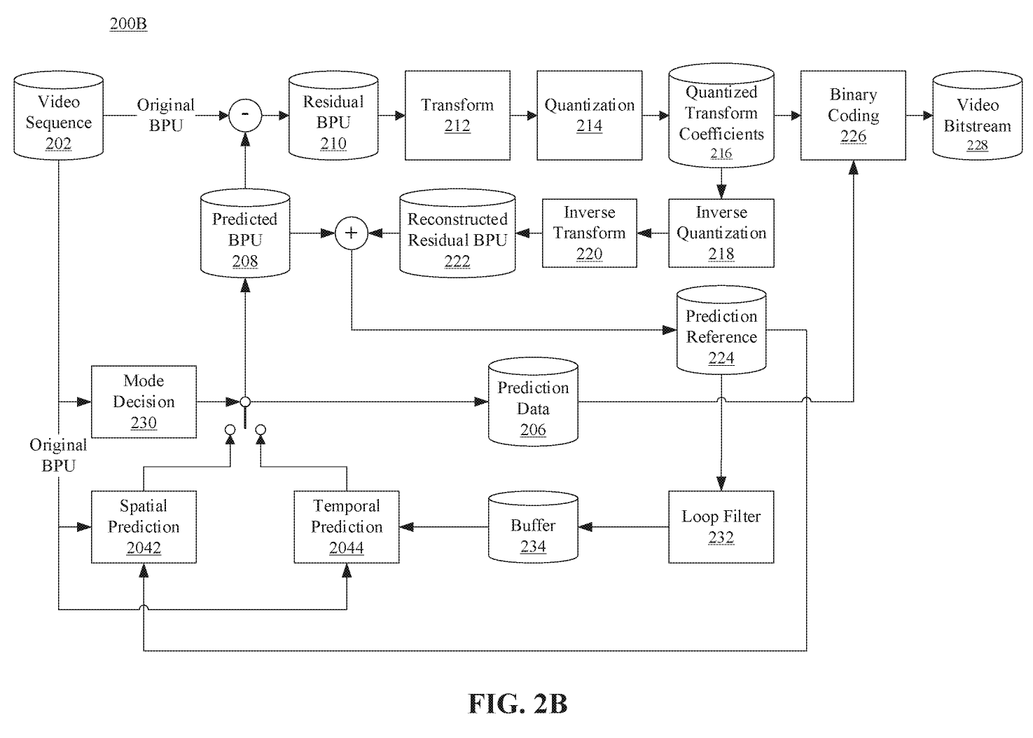

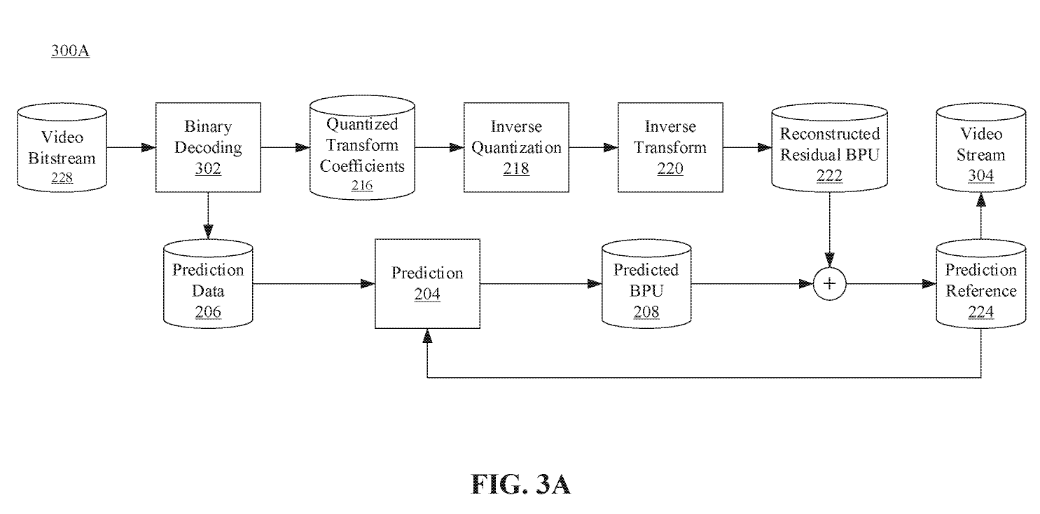

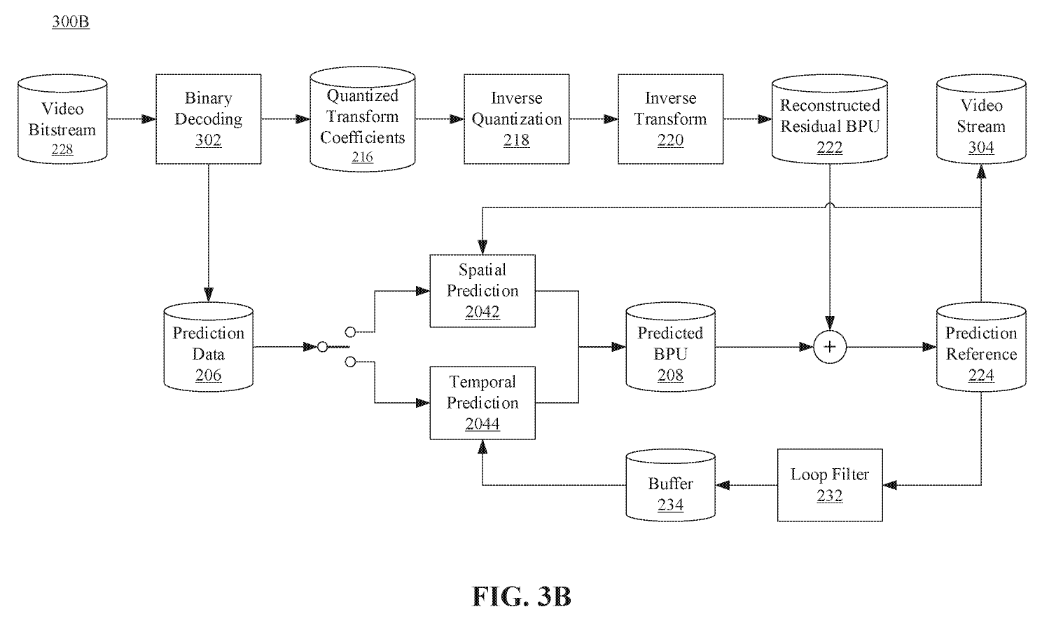

Video coding has multiple stages of operations, examples of which are shown in FIGS. 2A-2B and 3A-3B. For each stage, the size of the basic processing units can still be too large for processing and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2 B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC) and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A and 2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same coding unit (CU) can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210,212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization syntax element or any other syntax element of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, syntax elements of the prediction operation, a transform type at transform stage 212, syntax elements of the quantization process (e.g., quantization syntax elements), an encoder control syntax element (e.g., a bitrate control syntax element), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, syntax elements of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer (DPB)”) for later use (e.g., to be used as an inter-prediction reference picture for a future picture of video sequence 202). The encoder can store one or more reference pictures in buffer 234 to be used at temporal prediction stage 2044. In some embodiments, the encoder can encode syntax elements of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A and 2B), generally, video stream 304 is not identical to video sequence 202. Similar to processes 200A and 200B in FIGS. 2A and 2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, syntax elements of the prediction operation, a transform type, syntax elements of the quantization process (e.g., quantization syntax elements), an encoder control syntax element (e.g., a bitrate control syntax element), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044 and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, syntax elements of the intra prediction operation, or the like. The syntax elements of the intra prediction operation can include, for example, locations (e.g., coordinates) of one or more neighboring BPUs used as a reference, sizes of the neighboring BPUs, syntax elements of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, syntax elements of the inter prediction operation, or the like. The syntax elements of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer (DPB) in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include syntax elements of the loop filter (e.g., a loop filter strength). In some embodiments, prediction data includes syntax elements of the loop filter when the prediction mode indicator of prediction data 206 indicates that inter prediction was used to encode the current BPU.

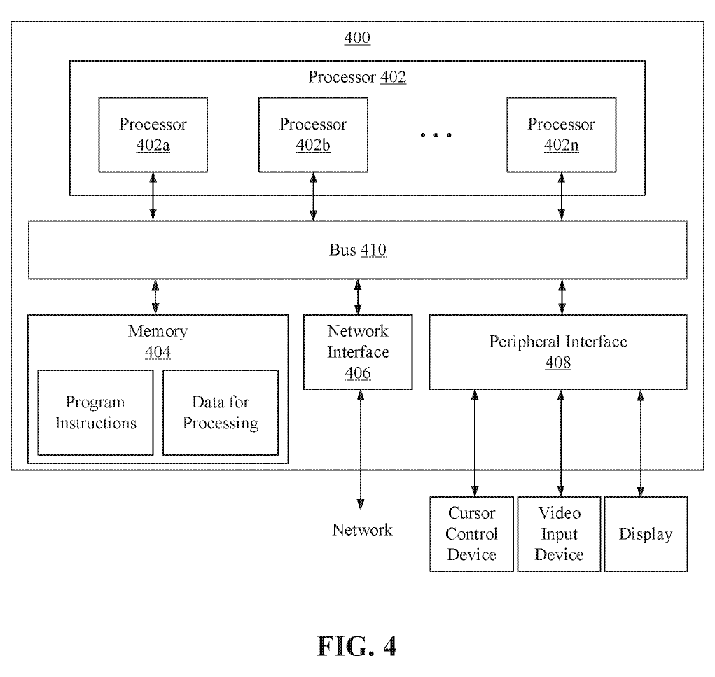

FIG. 4 is a block diagram of an exemplary apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410) and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

An Enhanced Compression Model (ECM) has been proposed and has been used as a new software base for developing tools beyond the VVC standard.

Subblock-based temporal motion vector predictor is described follows. In VVC, Temporal Motion Vector Prediction (TMVP) for Advanced Motion Vector Prediction (AMVP) and a merge mode are derived by fetching the motion information from the center or the bottom-right of a collocated block in a signaled collocated picture. The bottom-right of the collocated block is firstly checked, if there is no valid motion from the bottom-right position, the center block is followed. Similarly, for the Subblock-based Temporal Motion Vector Prediction (SbTMVP) mode, the motion information from the left neighboring position is used as a motion shift, which is then employed to obtain TMVPs at sub-CU level.

In ECM, to further improve the coding efficiency of TMVP or SbTMVP, three aspects are modified. Firstly, both bottom-right and center of the collocated block are checked. If both positions contain valid motion information and there are slots available in the candidate list, the motion vectors from both positions are included as TMVP candidates. Secondly, two collocated pictures are utilized for SbTMVP mode which are the two reference frames with the least picture order count (POC) distance relative to the to-be-coded frame. Thirdly, the SbTMVP’s motion shift to locate TMVP is adaptively determined from multiple locations according to template costs. More specifically, two motion shift candidate lists are constructed respectively for the two collocated frames. The motion shifts with the minimum template matching cost are used to derive SbTMVP. At most four SbTMVP candidates are included in the sub-block-based merge list. The SbTMVP candidate with the least template matching cost derived from the first collocated frame is placed in the first entry without reordering, while other SbTMVP candidates are sorted together with affine candidates. In addition, the prediction direction of each subblock template is determined based on the center subblock.

Chained motion vector prediction (CMVP) is described as follows. The CMVP candidates are introduced as one of merge candidates and are inserted after History-based Motion Vector Prediction (HMVP) candidates for regular merge and Template Matching (TM) merge modes. The CMVP candidates are derived as the accumulation of the recursively traced motion vectors (MVs) and block vectors (BVs) based on the pre-derived MVs. In the conventional design, CMVP candidates can be derived for each merge index and each reference picture list. The traceable reference pictures are restricted to the reference pictures in the reference picture list.

More additional CMVP candidates are added right before the zero padding candidates in the initial merge candidate list. Meanwhile, the maximum size of the initial merge candidate list is increased by 4. The maximum number of the candidates before the original CMVP candidates is kept unchanged.

When deriving the additional CMVP candidates, only the center position of the current block is checked to find traced MVs or BVs.

TMVP candidates with MV scaled to reference picture with index 0 are added if the existed TMVP candidates have non-zero reference index. The additional TMVP candidates are used to derive CMVP candidates. After TMVP and the related CMVP candidates are derived, Adaptive Reordering of Merge Candidates (ARMC) is performed. CMVP candidates are derived in Bilateral Matching (BM) merge mode as well.

Merge list construction in ECM is described as follows. In ECM, the merge candidate list is constructed by including the following seven types of candidates in order:
Spatial MVP from spatial neighbor CUs;
Temporal MVP from collocated blocks;
Non-adjacent spatial candidates;
History-based MVP from a first-in-first-out (FIFO) table;
Chained motion vector prediction;
Pairwise average MVP; and
Zero MVs.

Besides, after the merge candidate list is constructed, the merge candidates are reordered (hereinafter referred to as ARMC) according to cost values based on template matching. The template matching cost of a merge candidate is measured by the sum of absolute differences (SAD) between samples of a template of the current block and their corresponding reference samples. The template comprises a set of reconstructed samples neighboring to the current block. Reference samples of the template are located by the motion information of the merge candidate.

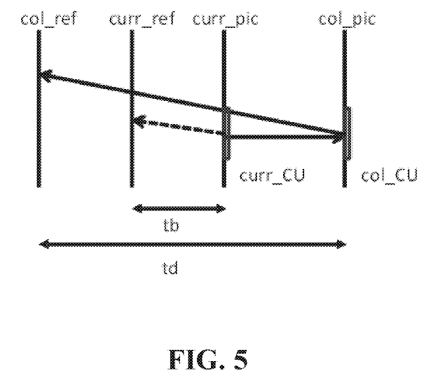

Next, temporal candidate derivation is described. In the derivation of the temporal merge candidate, a scaled motion vector is derived based on collocated block belonging to the collocated reference picture. The reference picture list and the reference index to be used for derivation of the collocated block is explicitly signaled in the slice header. FIG. 5 illustrates exemplary motion vector scaling for temporal merge candidate, according to some embodiments of the present disclosure. As shown in FIG. 5, the scaled motion vector for temporal merge candidate is obtained as illustrated by the dotted line, which is scaled from the motion vector of the collocated block using the POC distances, tb and td, where tb is defined to be the POC difference between the reference picture of the current picture and the current picture and td is defined to be the POC difference between the reference picture of the collocated picture and the collocated picture. The reference picture index of temporal merge candidate is set to a reference picture where the scaling factor is closest to 1.

It is noted that when deriving temporal merge candidate, the scaled motion vector is derived from one of motion of the collocated block, wherein the one of motion of the collocated block is determined according to the following rules:
If the motion of the collocated block is a bi-predicted motion and the current picture is a low delay picture, the L0 motion of the TMVP is scaled from the L0 motion of the collocated block and the L1 motion of the TMVP is scaled from the L1 motion of the collocated block.
Otherwise, if the motion of the collocated block is a bi-predicted motion and the current picture is a non-low delay picture, which one of the two motion of the collocated block is used to perform scaling is determined according to the reference picture list of the collocated block. More specifically, if the collocated block is from the L0 reference picture list, the L0 and L1 motion of the TMVP are both scaled from the L1 motion of the collocated block. Similarly, if the collocated block is from the L1 reference picture list, the L0 and L1 motion of the TMVP are both scaled from the L0 motion of the collocated block.
Otherwise, if the motion of the collocated block is a L0-predicted motion, the L0 and L1 motion of the TMVP are both scaled from the L0 motion of the collocated block no matter whether the current picture is a low-delay picture or not. Similarly, if the motion of the collocated block is a L1-predicted motion, the L0 and L1 motion of the TMVP are both scaled from the L1 motion of the collocated block.

When a collocated block is non-inter coded, which means motion is not available, the scaled motion vector of this collocated block is treated as not available. Besides, in the conventional ECM design, the TMVP can only be derived from one collocated picture, and the TMVP candidates can be either L0-predicted, L1-predicted or bi-predicted.

Next, AMVP list construction in ECM is described. In ECM, the AMVP list is constructed by including the following four types of candidates in order:
Spatial MVP from spatial neighbor CUs;
Temporal MVP from collocated blocks;
Non-adjacent spatial candidates; and
History-based MVP from an FIFO table.

The TM process is applied to the AMVP list to reorder candidates.

The TMVP is restricted to derive from only one collocated picture. However, the SbTMVP and CMVP allow to obtain temporal motion from multiple reference pictures. Moreover, the TMVP cannot be obtained from BV. These restrictions may limit the prediction efficiency of TMVP.

The present disclosure provides solutions to one or more of the above-described problems, for next generation of video coding.

Embodiments of the present disclosure provide a method of deriving TMVP from multiple reference pictures. Consistent with the present disclosure, it is proposed to allow TMVP to derive from multiple reference pictures instead of only one collocated picture.

In some embodiments, TMVP candidates are derived from two collocated pictures, which are the two reference frames with the least POC distance relative to the to-be-coded frame. The two reference frames may be the same as those used in SbTMVP mode.

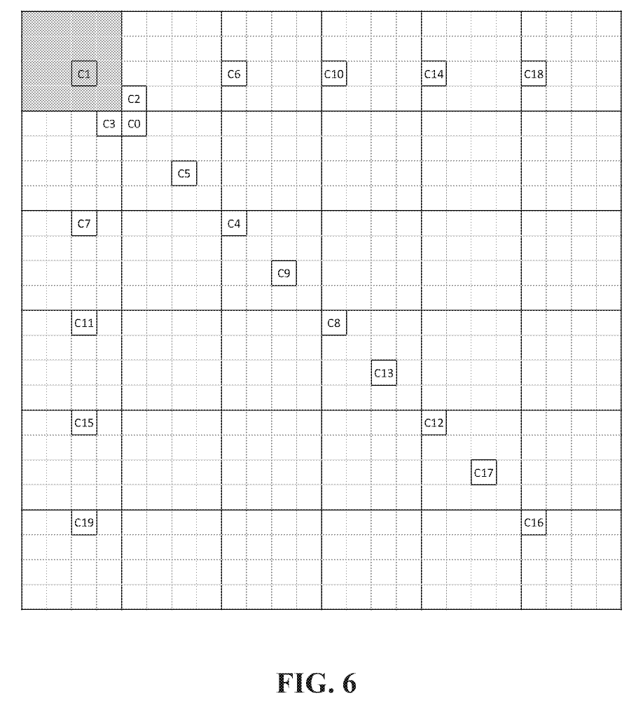

In some embodiments, when adding TMVP candidates to a merge list or an AMVP list, multiple collocated blocks are checked. FIG. 6 illustrates exemplary positions for collocated blocks, according to some embodiments of the present disclosure. When two reference frames are used to derive TMVP candidates, motions for the two reference frames can be added in different orders.

In one example, the motions from first frame and the motions from second reference frame are added in sequence. For example, motions from collocated blocks (for example, motions from positions C0, C1, C2,…) of a first reference picture are firstly added, then motions from collocated blocks (for example, motions from positions C0, C1, C2, …) of a second reference picture are added. In this example, as shown in FIG. 6, a collocated block includes 4×4 sub-blocks, and a reference picture includes 6×6 blocks. It can be understood that in some embodiments, the sizes of a collocated block and a reference picture can vary.

In another example, the motions from first picture and the motions from second reference picture are added alternately. For example, a motion from C0 position of first and second reference frame are added followed by the motion from C1 position of first and second reference frames, and so on.

In some embodiments, TMVP candidates are derived from any one of reference pictures in the reference picture list.

In some embodiments, the number of reference pictures used in TMVP derivation may be dependent on coding mode. For example, the number of reference pictures are set to N1, N2, N3, N4, N5, N6, N7, and N8 for regular merge, Combined Inter and Intra Prediction (CIIP), BM, TM, Merge Mode with Motion Vector Difference (MMVD), Affine, SbTMVP, and AMVP mode, respectively. The values of N1, N2, N3, N4, N5, N6, N7 and N8 are positive integer numbers, and may be the same or different from each other.

Embodiments of the present disclosure provide methods of deriving TMVP from BV. In the present disclosure, it is proposed to obtain TMVP from BVs instead from motion vectors.

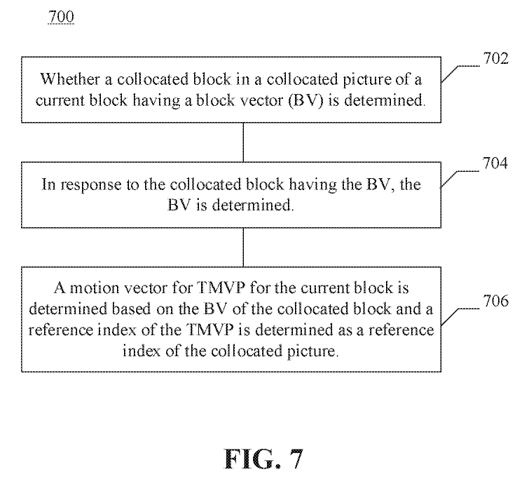

FIG. 7 is a flowchart of an exemplary method for deriving a motion vector for TMVP from BV, according to some embodiments of the present disclosure. Method 700 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 700. In some embodiments, method 700 can be implemented by a computer program product, embodied in a computer-readable medium, including computer-executable instructions, such as program code, executed by computers (e.g., apparatus 400 of FIG. 4). Referring to FIG. 7, method 700 may include the following steps 702 to 706.

At step 702, whether a collocated block in a collocated picture of a current block having a block vector (BV) is determined. For example, when a collocated block is coded using Intra Block Copy (IBC) or an Intra Template Matching Prediction (IntraTMP) mode, the collocated block has a BV. In some embodiments, whether the collocated block being BV-coded is determined.

At step 704, in response to the collocated block having the BV, the BV is determined.

At step 706, a motion vector for TMVP for the current block is determined based on the BV of the collocated block and a reference index of the TMVP is determined as a reference index of the collocated picture. A TMVP candidate may include the motion vector and the reference index.

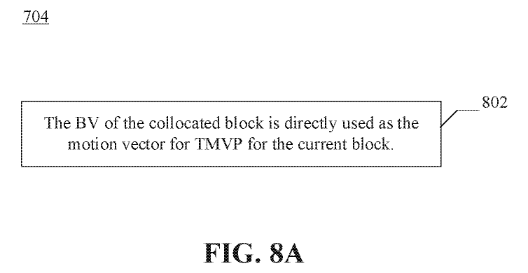

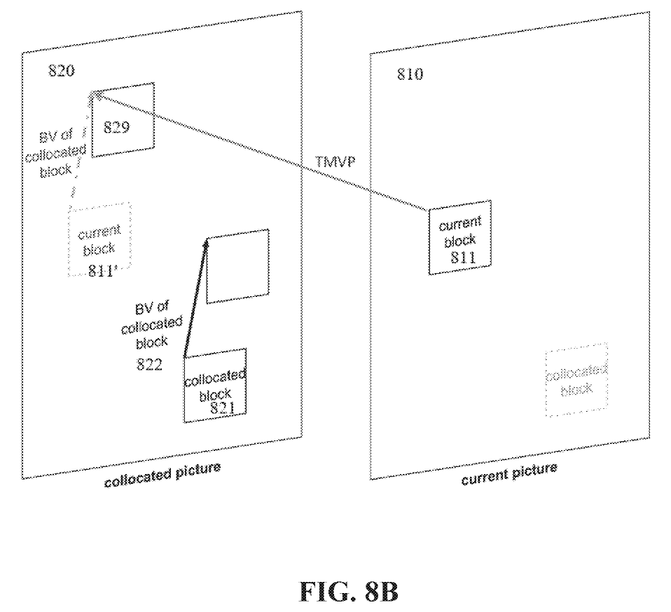

In some embodiments, the BV of the collocated block is directly used as a TMVP candidate of the current block. FIG. 8A is a flowchart of an exemplary sub-step of a method for deriving a motion vector for TMVP from BV, according to some embodiments of the present disclosure. As shown in FIG. 8A, step 706 of method 700 further includes step 802. In step 802, the BV of the collocated block is directly used as the motion vector for TMVP for the current block. FIG. 8B illustrates an exemplary diagram consistent with the method in FIG. 8A, according to some embodiments of the present disclosure. Referring to FIG. 8B, block 821 in collocated picture 820 is the collocated block of current block 811 in current picture 810. BV 822 is the BV of collocated block 821. Block 811’ illustrates a corresponding position in collocated picture 820 for current block 811. In this example, BV 822 of collocated block 821 is directly used as the motion vector for the TMVP of current block 811. Therefore, a predicted block 829 for current block 811 by TMVP is obtained based on the determined motion vector (e.g., BV 822).

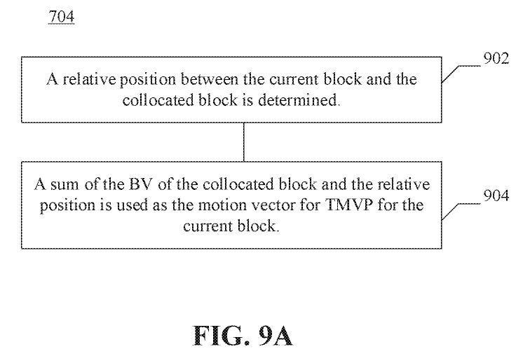

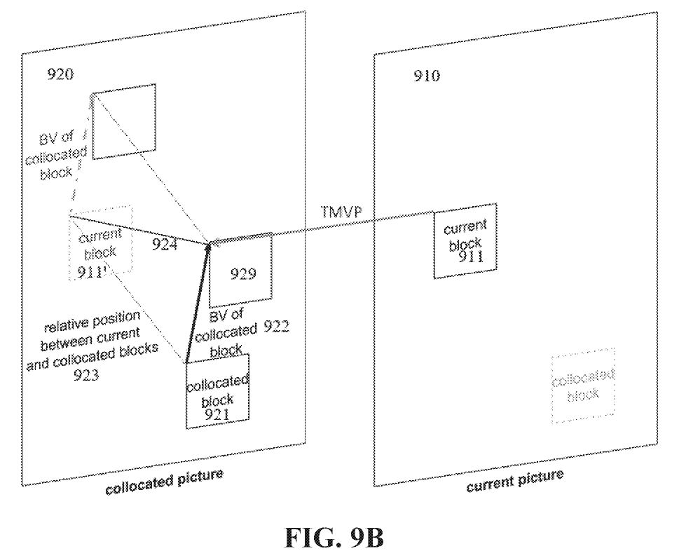

In some embodiments, when obtaining TMVP from a BV-coded collocated block, the relative position of current block and collocated block is considered. That is, TMVP of the current block is performed based on the BV of the collocated block and a relative position between the current block and the collocated block. FIG. 9A is a flowchart of another exemplary sub-step of a method for deriving a motion vector for TMVP from BV, according to some embodiments of the present disclosure. As shown in FIG. 9A, step 706 of method 700 further includes steps 902 and 904. In step 902, a relative position between the current block and the collocated block is determined. In step 904, a sum of the BV of the collocated block and the relative position is used as the motion vector for TMVP for the current block. The sum is a vector. FIG. 9B illustrates an exemplary diagram consistent with the method in FIG. 9A, according to some embodiments of the present disclosure. Referring to FIG. 9B, block 921 in collocated picture 920 is the collocated block of current block 911 in current picture 910. BV 922 is the BV of collocated block 921. Block 911’ illustrates a corresponding position in collocated picture 920 for current block 911. A relative position 923 between current block 911’ and collocated block 921 is determined. The relative position 923 is a vector. A sum 924 of relative position 923 and BV 922 is obtained. In this example, sum 924 is used as the motion vector for TMVP of current block 911. Therefore, a predicted block 929 for current block 921 by TMVP is obtained based on the determined motion vector (i.e., sum 924). In this example, position of a block refers to a top-left point of the block.

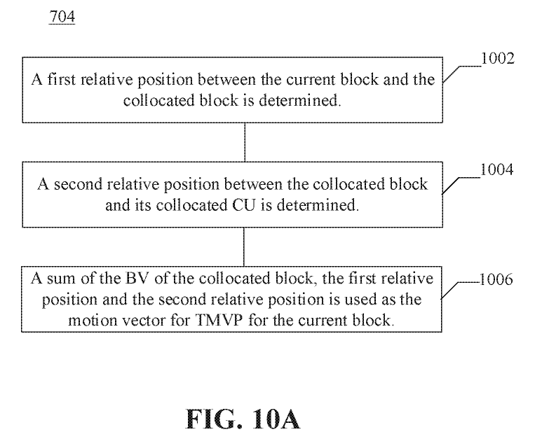

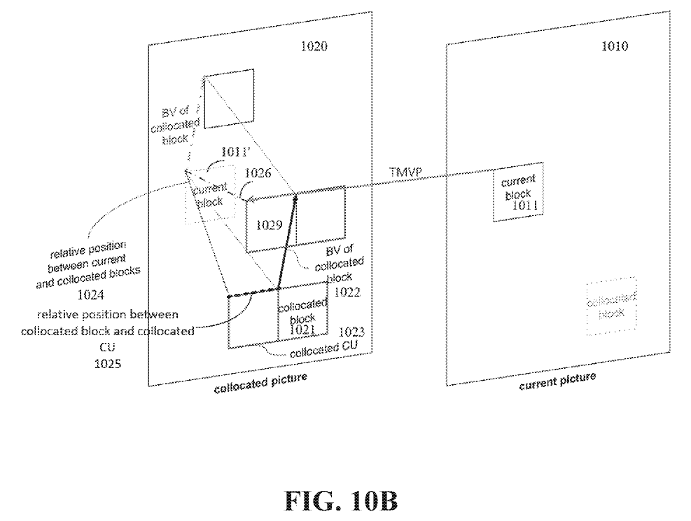

In conventional implementations, the temporal information of reference pictures is stored in 4×4 subblock-based. When obtaining TMVP from a collocated block, the CU size of that collocated block is not considered. In some embodiments, it is proposed that when obtaining TMVP from a BV-coded collocated block, not only the relative position between current block and collocated block are considered, but also the CU size of the collocated block is considered. That is, TMVP of the current block is performed based on the BV of the collocated block, a relative position between the current block and the collocated block, and a CU size of the collocated block. FIG. 10A is a flowchart of another exemplary sub-step of a method for deriving a motion vector for TMVP from BV, according to some embodiments of the present disclosure. As shown in FIG. 10A, step 706 of method 700 further includes steps 1002 to 1006. In step 1002, a first relative position between the current block and the collocated block is determined. In step 1004, a second relative position between the collocated block and its collocated CU is determined. In step 1006, a sum of the BV of the collocated block, the first relative position and the second relative position is used as the motion vector for TMVP for the current block. The sum is a vector. FIG. 10B illustrates an exemplary diagram consistent with the method in FIG. 10A, according to some embodiments of the present disclosure. Referring to FIG. 10B, block 1021 in collocated picture 1020 is the collocated block of current block 1011 in current picture 1010. BV 1022 is the BV of collocated block 1021. Block 1011’ illustrates a corresponding position in collocated picture 1020 for current block 1011. Collocated block 1021 is included in collocated CU 1023. A first relative position 1024 between current block 1011’ and collocated block 1024 is determined, and a second relative position 1025 between collocated block 1021 and collocated block 1023 is determined. The relative positions 1024 and 1025 are vectors. Then, a sum 1026 of BV 1022, first relative position 1024, and second relative position 1025 is obtained. In this example, sum 1026 is used as the motion vector for TMVP for current block 1011. Therefore, a predicted block 1029 of current block 1011 by TMVP is obtained based on the determined motion vector (i.e., sum 1026). In this example, position of a block or a CU refers to a top-left point of the block or the CU.

In some embodiments, the proposed deriving TMVP candidates from BV-coded collocated blocks can be used for one of regular merge mode, CIIP mode, BM mode, TM mode, MMVD mode, Affine mode, SbTMVP mode, and AMVP mode. It is not required that the TMVP derivation is the same for all coding modes in a codec. In one example, regular merge, TM, CIIP, and MMVD modes are allowed to derive TMVP candidates from BV-coded collocated blocks. In another example, only regular merge mode is allowed to derive TMVP candidates from BV-coded collocated blocks.

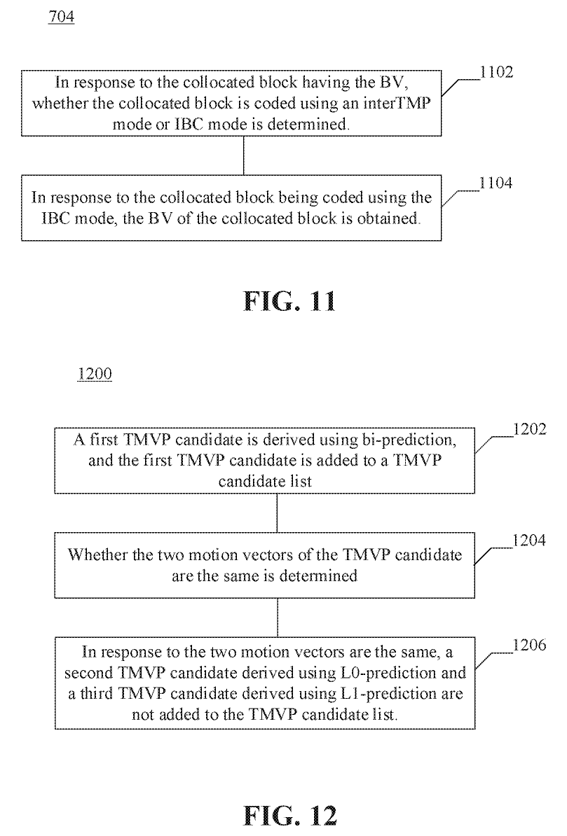

In conventional ECM implementation, both IBC and intraTMP modes are BV-coded. However, in the intraTMP mode, more than two BVs are used to predict an intraTMP-coded block. When using these intraTMP-coded blocks as collocated block for TMVP, the BVs may not be accurate. Therefore, in some embodiments, it is proposed to derive TMVP candidates from IBC-coded collocated blocks. That is, the TMVP candidates cannot be derived from intraTMP-coded collocated blocks. FIG. 11 is a flowchart of another exemplary sub-steps of a method for deriving a motion vector for TMVP from BV, according to some embodiments of the present disclosure. According to FIG. 11, step 704 of method 700 further includes steps 1102 and 1104.

At step 1102, in response to the collocated block having the BV, whether the collocated block is coded using an intraTMP mode or IBC mode is determined.

At step 1104, in response to the collocated block being coded using the IBC mode, the BV of the collocated block is obtained. And then, step 706 of method 700 is performed.

Embodiments of the present disclosure further provide methods for TMVP derivation. In the conventional ECM merge list design, three TMVP candidates (e.g., bi-predicted, L0-predicted, and L1-predicted TMVPs) may be derived for each collocated block. However, these three TMVP candidates may be identical due to the derivation process as described before. In the present disclosure, it is proposed to check whether two MVs of bi-predicted TMVP are the same as each other. In case that the two MVs of bi-predicted TMVP are the same as each other, the L0-predicted and L1-predicted TMVPs are not added to the list.

FIG. 12 is a flowchart of an exemplary method for constituting a TMVP candidate list, according to some embodiments of the present disclosure. Method 1200 can be performed by an encoder (e.g., by process 200A of FIG. 2A or 200B of FIG. 2B), performed by a decoder (e.g., by process 300A of FIG. 3A or 300B of FIG. 3B), or performed by one or more software or hardware components of an apparatus (e.g., apparatus 400 of FIG. 4). For example, a processor (e.g., processor 402 of FIG. 4) can perform method 1200. In some embodiments, method 1200 can be implemented by a computer program product, embodied in a computer-readable medium, including computer-executable instructions, such as program code, executed by computers (e.g., apparatus 400 of FIG. 4). Referring to FIG. 12, method 1200 may include the following steps 1202 to 1206.

At step 1202, a first TMVP candidate is derived using bi-prediction, and the first TMVP candidate is added to a TMVP candidate list. The TMVP candidate includes two motion vectors.

At step 1204, whether the two motion vectors of the TMVP candidate are the same is determined.

At step 1206, in response to the two motion vectors are the same, a second TMVP candidate derived using L0-prediction and a third TMVP candidate derived using L1-prediction are not added to the TMVP candidate list. In some embodiments, the derivation of the second TMVP candidate and the third TMVP candidates using L1- prediction and L0-prediction is skipped.

Embodiments of the present disclosure further provide methods of constructing merge list or AMVP list. In conventional ECM design, the merge list or AMVP list includes spatial candidates, temporal candidates, non-adjacent spatial, and History-based Motion Vector Prediction (HMVP) candidates, and the order of adding candidate types to merge list or AMVP list construction is fixed. The spatial candidates are always added before the temporal candidates, and the non-adjacent spatial and HMVP candidates are always added after the temporal candidates. However, the temporal candidates are more accurate than the spatial candidates when the collocated picture is close to the current picture, while when the collocated picture is far from the current picture, the spatial candidates are more accurate than the temporal candidates. In the present disclosure, it is proposed to adaptive reorder the candidate list construction according to the POC distance between current picture and its collocated picture.

In some embodiments, a picture order count (POC) distance between a current picture and its collocated picture is determined, and the candidate merge list is constructed based on the POC distance. In some embodiments, whether the POC distance is smaller than a threshold N1 is determined, wherein the threshold N1 is a positive number. The threshold N1 can be a pre-defined value. The threshold N can also be signaled at SPS, PPS, picture header, slice header, coding tree unit (CTU) or CU level. When the POC distance between the current picture and its collocated picture is smaller than the threshold N1, the temporal candidates are added before spatial candidates. When the POC distance between current picture and its collocated picture is larger than or equal to the threshold N1, the spatial candidates are added before the temporal candidates. In one example, the threshold N1 is set equal to 1.

In some embodiments, whether the POC distance is smaller than a threshold N2 is determined, wherein the threshold N2 is a positive number. The threshold N2 can be a pre-defined value. The threshold N2 can also be signaled at SPS, PPS, picture header, slice header, CTU or CU level. When the POC distance between current picture and its collocated picture is smaller than the threshold N2, the temporal candidates are added before non-adjacent spatial candidates. When the POC distance between current picture and its collocated picture is larger than or equal to the threshold N2, the non-adjacent spatial candidates are added before the temporal candidates. In one example, the threshold N2 is set equal to 2.

In some embodiments, whether the POC distance is smaller than a threshold N3 is determined, wherein the threshold N3 is a positive number. The threshold N3 can be a pre-defined value. The threshold N3 can also be signaled at SPS, PPS, picture header, slice header, CTU or CU level. When the POC distance between current picture and its collocated picture is smaller than a threshold N3, the temporal candidates are added before non-adjacent spatial candidates and HMVP candidates. When the POC distance between current picture and its collocated picture is larger than or equal to the threshold N3, the temporal candidates are added after non-adjacent spatial candidates and HMVP candidates. In one example, the threshold N3 is set equal to 4.

In some embodiments, adaptive reordering the candidate list construction is based on temporal layer. For example, a temporal layer of a current picture is determined, and the candidate merge list is constructed based on the temporal layer. In some embodiments, whether the temporal layer is smaller than a threshold M is determined. The threshold M is zero or a positive integer number. The threshold M can be a pre-defined value. The threshold M can be signaled at SPS, PPS, picture header, slice header, CTU or CU level. When temporal layer of the current picture is smaller than the threshold M (that is, the collocated picture has higher probability far from the current picture), the non-adjacent spatial candidates are added before the temporal candidates. When the temporal layer of the current picture is larger than or equal to the threshold M, the non-adjacent spatial candidates are added after the temporal candidates. In one example, the threshold M is set equal to 5.

In some embodiments, a flag is signaled to indicate how the candidate list is constructed, for example, the construction order of the candidates. The flag can be signaled at SPS, PPS, picture header, slice header, CTU or CU level. In one example, the flag is signaled at CU level to indicate whether the temporal candidates are added before the spatial candidates. In another example, the flag is signaled at slice header to indicate whether the temporal candidates are added after the non-adjacent spatial candidates.

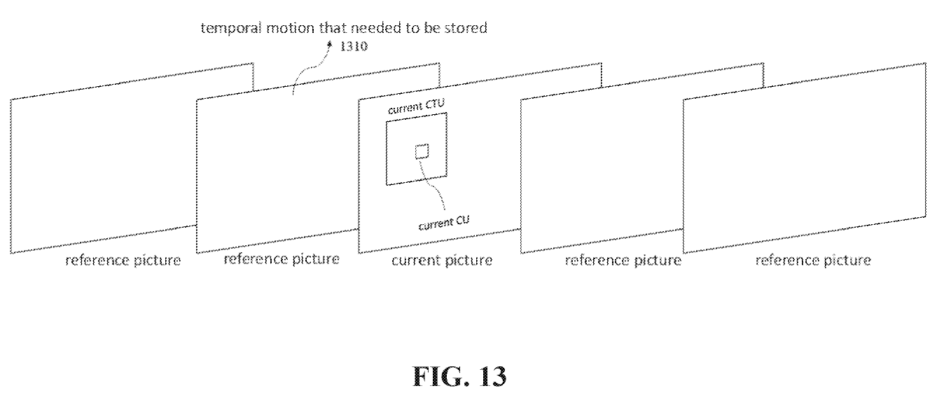

Embodiments of the present disclosure provide methods for applying collocated area for TMVP. Due to CMVP, the temporal motion can be derived from any one of reference picture. FIG. 13 illustrates temporal motion that needed to be stored, according to the prior art. As shown in FIG. 13, gray areas 1310 are used to derive TMVP candidates. That is, all the CTU temporary motions are stored. However, this design may require lots of memory to store temporal motion which is not practical for real hardware implementation. In the present disclosure, it is proposed to store only a few CTU temporal motion for each reference picture.

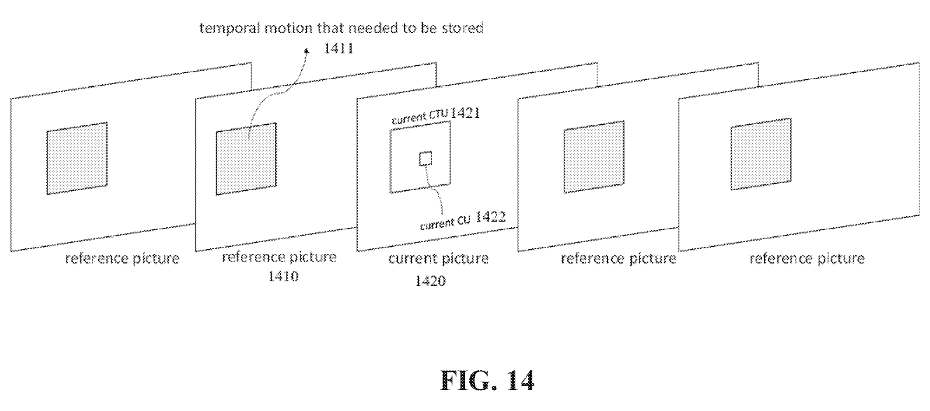

FIG. 14 illustrates exemplary temporal motion that needed to be stored, according to some embodiments of the present disclosure. As shown in FIG. 14, only one CTU temporal motion 1421 is stored for each reference picture. The position of the CTU temporal motion 1421 in the reference picture 1420 corresponds to the position of the current CTU 1411 of current picture 1410. Current CTU 1411 includes a current CU 1412.

In some embodiments, the number of CTU temporal motion needed to be stored are determined according to the POC distance between current picture and each reference picture. When the reference picture is closer to the current picture, more temporal motion are stored. For example, when the POC distance between current picture and its collocated picture is smaller than a threshold N, a first number of CTU temporal motions are stored. When the POC distance between current picture and its collocated picture is greater than or equal to the threshold N, a second number of CTU temporal motions are stored. The first number is greater than the second number. The threshold N is a positive number, and the threshold N can be a pre-defined value. In some embodiments, the position of the CTU temporal motions in the reference picture corresponds to the position of the current CTU. If there is more than one CTU temporal motion stored. The area of the CTU temporal motions in the reference picture is expanded with a center of the position corresponding to the current CTU.

The embodiments described in the present disclosure can be freely combined.

In some embodiments, a non- transitory computer readable medium storing a bitstream is provided. The bitstream is generated by receiving a video sequence and encoding the video sequence to generate coded information included in the bitstream. The bitstream can be transmitted to a decoder for decoding. The video sequence is encoded by the above-described methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:

1. A method for encoding a video sequence, the method comprising:

receiving a video sequence; and

encoding the video sequence by:

determining whether a collocated block in a collocated picture of a current block has a block vector (BV);

in response to the collocated block having the BV, determining the BV;

determining a motion vector for Temporal Motion Vector Prediction (TMVP) for the current block based on the BV of the collocated block; and

determining a reference index of the TMVP to be a reference index of the collocated picture.

2. The method according to clause 1, wherein determining the motion vector for TMVP for the current block based on the BV of the collocated block further comprises:

using the BV of the collocated block as the motion vector for TMVP for the current block.

3. The method according to clause 1, wherein determining the motion vector for TMVP for the current block based on the BV of the collocated block further comprises:

determining a relative position between the current block and the collocated block; and

using a sum of the BV of the collocated block and the relative position as the motion vector for TMVP for the current block.

4. The method according to clause 1, wherein determining the motion vector for TMVP for the current block based on the BV of the collocated block further comprises:

determining a first relative position between the current block and the collocated block;

determining a second relative position between the collocated block and its collocated coding unit, wherein the collocated coding unit includes the collocated block; and

using a sum of the BV of the collocated block, the first relative position, and the second relative position as the motion vector for TMVP for the current block.

5. The method according to clause 1, wherein in response to the collocated block having the BV, determining the BV further comprises:

in response to the collocated block having the BV, determining whether the collocated block is coded using an Intra Template Matching Prediction (IntraTMP) mode or an Intra Block Copy (IBC) mode; and

in response to the collocated block being coded using the IBC mode, obtaining the BV of the collocated block.

6. The method according to clause 1, wherein the collocated block is coded using an Intra Template Matching Prediction (IntraTMP) mode or an Intra Block Copy (IBC) mode.

7. The method according to clause 1, wherein the current block is coded using at least one of: regular merge mode, Combined Inter and Intra Prediction (CIIP) mode, Bi-directional Motion (BM) mode, Template Matching (TM) mode, Merge Mode with Motion Vector Difference (MMVD) mode, Affine mode, Subblock-based Temporal Motion Vector Prediction (SbTMVP) mode, or Advanced Motion Vector Prediction (AMVP) mode.

8. The method according to clause 1, further comprising:

storing a bitstream that is generated based on the encoding.

9. A method for encoding a video sequence, the method comprising:

receiving a video sequence; and

encoding the video sequence by:

adaptively constructing a candidate merge list including spatial candidates, temporal candidates, non-adjacent spatial candidates, and History-based Motion Vector Prediction (HMVP) candidates.

10. The method according to clause 9, wherein adaptively constructing the candidate merge list comprises:

determining a picture order count (POC) distance between a current picture and its collocated picture; and

constructing the candidate merge list based on the POC distance.

11. The method according to clause 10, wherein constructing the candidate merge list based on the POC distance further comprises:

determining whether the POC distance is smaller than a threshold;

in response to the POC being smaller than the threshold, adding the temporal candidates before the spatial candidates; or

in response to the POC being greater than or equal to the threshold, adding the spatial candidates before the temporal candidates.

12. The method according to clause 10, wherein constructing the candidate merge list based on the POC distance further comprises:

determining whether the POC distance is smaller than a threshold;

in response to the POC being smaller than the threshold, adding the temporal candidates before the non-adjacent spatial candidates; or

in response to the POC being greater than or equal to the threshold, adding the non-adjacent spatial candidates before the temporal candidates.

13. The method according to clause 10, wherein constructing the candidate merge list based on the POC distance further comprises:

determining whether the POC distance is smaller than a threshold;

in response to the POC being smaller than the threshold, adding the temporal candidates before the non-adjacent spatial candidates and the HMVP candidates; or

in response to the POC being greater than or equal to the threshold, adding the non-adjacent spatial candidates and the HMVP candidates before the temporal candidates.

14. The method according to clause 11, wherein the encoding further comprises:

encoding the threshold at SPS, PPS, picture header, slice header, coding tree unit (CTU), or coding unit level.

15. The method according to clause 9, wherein adaptively constructing the candidate merge list further comprises:

determining a temporal layer of a current picture; and

constructing the candidate merge list based on the temporal layer.

16. The method according to clause 15, wherein constructing the candidate merge list based on the temporal layer further comprises:

determining whether the temporal layer is smaller than a threshold;

in response to the temporal layer being smaller than the threshold, adding the non-adjacent spatial candidates before the temporal candidates; or

in response to the temporal layer being greater than or equal to the threshold, adding the temporal candidates before the non-adjacent spatial candidates.

17. The method according to clause 16, wherein the encoding further comprises:

encoding the threshold at SPS, PPS, picture header, slice header, coding tree unit (CTU), or coding unit level.

18. The method according to clause 9, wherein adaptively constructing the candidate merge list further comprises:

encoding a flag indicating whether to add temporal candidates before spatial candidates;

in response to the flag being a first value, adding the temporal candidates before the spatial candidates; or

in response to the flag being a second value, adding the spatial candidates before the temporal candidates.

19. The method according to clause 18, wherein the flag is encoded at coding unit level.

20. The method according to clause 9, wherein adaptively constructing a candidate merge list further comprises:

encoding a flag indicating whether to add temporal candidates before non-adjacent spatial candidates;

in response to the flag being a first value, adding the temporal candidates before the spatial candidates; or

in response to the flag being a second value, adding the non-adjacent spatial candidates before the temporal candidates.

21. The method according to clause 20, wherein the flag is encoded at a slice header.

22. The method according to clause 9, further comprising:

storing a bitstream that is generated based on the encoding.

23. A method for decoding a bitstream, the method comprising:

receiving a bitstream; and

decoding the bitstream to generate a video sequence, the decoding comprising:

determining whether a collocated block in a collocated picture of a current block has a block vector (BV);

in response to the collocated block having the BV, determining the BV;

determining a motion vector for Temporal Motion Vector Prediction (TMVP) for the current block based on the BV of the collocated block; and

determining a reference index of the TMVP to be a reference index of the collocated picture.

24. The method according to clause 23, wherein determining the motion vector for TMVP for the current block based on the BV of the collocated block further comprises:

using the BV of the collocated block as the motion vector for TMVP for the current block.

25. The method according to clause 23, wherein determining the motion vector for TMVP for the current block based on the BV of the collocated block further comprises:

determining a relative position between the current block and the collocated block; and

using a sum of the BV of the collocated block and the relative position as the motion vector for TMVP for the current block.

26. The method according to clause 23, wherein determining the motion vector for TMVP for the current block based on the BV of the collocated block further comprises:

determining a first relative position between the current block and the collocated block;

determining a second relative position between the collocated block and its collocated coding unit, wherein the collocated coding unit includes the collocated block; and

using a sum of the BV of the collocated block, the first relative position, and the second relative position as the motion vector for TMVP for the current block.

27. The method according to clause 23, wherein in response to the collocated block having the BV, determining the BV further comprises:

in response to the collocated block having the BV, determining whether the collocated block is coded using an Intra Template Matching Prediction (IntraTMP) mode or an Intra Block Copy (IBC) mode; and

in response to the collocated block being coded using the IBC mode, obtaining the BV of the collocated block.

28. The method according to clause 23, wherein the collocated block is coded using an Intra Template Matching Prediction (IntraTMP) mode or an Intra Block Copy (IBC) mode.

29. A method for transmitting a bitstream, the method comprising:

receiving a video sequence;

encoding the video sequence by:

determining whether a collocated block in a collocated picture of a current block has a block vector (BV);

in response to the collocated block having the BV, determining the BV;

determining a motion vector for Temporal Motion Vector Prediction (TMVP) for the current block based on the BV of the collocated block; and

determining a reference index of the TMVP to be a reference index of the collocated picture; and

transmitting a bitstream that is generated based on the encoding.

30. The method according to clause 29, wherein determining the motion vector for TMVP for the current block based on the BV of the collocated block further comprises:

using the BV of the collocated block as the motion vector for TMVP for the current block.

31. The method according to clause 29, wherein determining the motion vector for TMVP for the current block based on the BV of the collocated block further comprises:

determining a relative position between the current block and the collocated block; and

using a sum of the BV of the collocated block and the relative position as the motion vector for TMVP for the current block.

32. The method according to clause 29, wherein determining the motion vector for TMVP for the current block based on the BV of the collocated block further comprises:

determining a first relative position between the current block and the collocated block;

determining a second relative position between the collocated block and its collocated coding unit, wherein the collocated coding unit includes the collocated block; and

using a sum of the BV of the collocated block, the first relative position, and the second relative position as the motion vector for TMVP for the current block.

33. The method according to clause 29, wherein in response to the collocated block having the BV, determining the BV further comprises:

in response to the collocated block having the BV, determining whether the collocated block is coded using an Intra Template Matching Prediction (IntraTMP) mode or an Intra Block Copy (IBC) mode; and

in response to the collocated block being coded using the IBC mode, obtaining the BV of the collocated block.

34. The method according to clause 29, wherein the collocated block is coded using an Intra Template Matching Prediction (IntraTMP) mode or an Intra Block Copy (IBC) mode.

35. A method for decoding a bitstream, the method comprising:

receiving a bitstream; and

decoding the bitstream to generate a video sequence, the decoding comprising:

adaptively constructing a candidate merge list including spatial candidates, temporal candidates, non-adjacent spatial candidates, and History-based Motion Vector Prediction (HMVP) candidates.

36. The method according to clause 35, wherein adaptively constructing the candidate merge list comprises:

determining a picture order count (POC) distance between a current picture and its collocated picture; and

constructing the candidate merge list based on the POC distance.

37. The method according to clause 36, wherein constructing the candidate merge list based on the POC distance further comprises:

determining whether the POC distance is smaller than a threshold;

in response to the POC being smaller than the threshold, adding the temporal candidates before the spatial candidates; or

in response to the POC being greater than or equal to the threshold, adding the spatial candidates before the temporal candidates.

38. The method according to clause 36, wherein constructing the candidate merge list based on the POC distance further comprises:

determining whether the POC distance is smaller than a threshold;

in response to the POC being smaller than the threshold, adding the temporal candidates before the non-adjacent spatial candidates; or

in response to the POC being greater than or equal to the threshold, adding the non-adjacent spatial candidates before the temporal candidates.

39. The method according to clause 36, wherein constructing the candidate merge list based on the POC distance further comprises:

determining whether the POC distance is smaller than a threshold;

in response to the POC being smaller than the threshold, adding the temporal candidates before the non-adjacent spatial candidates and the HMVP candidates; or

in response to the POC being greater than or equal to the threshold, adding the non-adjacent spatial candidates and the HMVP candidates before the temporal candidates.

40. The method according to clause 39, wherein the decoding further comprises:

decoding the threshold at SPS, PPS, picture header, slice header, coding tree unit (CTU), or coding unit level.

41. The method according to clause 35, wherein adaptively constructing the candidate merge list further comprises:

determining a temporal layer of a current picture; and

constructing the candidate merge list based on the temporal layer.

42. The method according to clause 41, wherein constructing the candidate merge list based on the temporal layer further comprises:

determining whether the temporal layer is smaller than a threshold;

in response to the temporal layer being smaller than the threshold, adding the non-adjacent spatial candidates before the temporal candidates; or

in response to the temporal layer being greater than or equal to the threshold, adding the temporal candidates before the non-adjacent spatial candidates.

43. The method according to clause 42, wherein the decoding further comprises:

decoding the threshold at SPS, PPS, picture header, slice header, coding tree unit (CTU), or coding unit level.

44. The method according to clause 35, wherein adaptively constructing the candidate merge list further comprises:

encoding a flag indicating whether to add temporal candidates before spatial candidates;

in response to the flag being a first value, adding the temporal candidates before the spatial candidates; or

in response to the flag being a second value, adding the spatial candidates before the temporal candidates.

45. The method according to clause 44, wherein the flag is encoded at coding unit level.

46. The method according to clause 35, wherein adaptively constructing a candidate merge list further comprises:

decoding a flag indicating whether to add temporal candidates before non-adjacent spatial candidates;

in response to the flag being a first value, adding the temporal candidates before the spatial candidates; or

in response to the flag being a second value, adding the non-adjacent spatial candidates before the temporal candidates.

47. The method according to clause 46, wherein the flag is encoded at a slice header.

48. A method for transmitting a bitstream, the method comprising:

receiving a video sequence;

encoding the video sequence by:

adaptively constructing a candidate merge list including spatial candidates, temporal candidates, non-adjacent spatial candidates, and History-based Motion Vector Prediction (HMVP) candidates; and

transmitting a bitstream that is generated based on the encoding.

49. The method according to clause 48, wherein adaptively constructing the candidate merge list comprises:

determining a picture order count (POC) distance between a current picture and its collocated picture; and

constructing the candidate merge list based on the POC distance.

50. The method according to clause 49, wherein constructing the candidate merge list based on the POC distance further comprises:

determining whether the POC distance is smaller than a threshold;

in response to the POC being smaller than the threshold, adding the temporal candidates before the spatial candidates; or

in response to the POC being greater than or equal to the threshold, adding the spatial candidates before the temporal candidates.

51. The method according to clause 49, wherein constructing the candidate merge list based on the POC distance further comprises:

determining whether the POC distance is smaller than a threshold;

in response to the POC being smaller than the threshold, adding the temporal candidates before the non-adjacent spatial candidates; or

in response to the POC being greater than or equal to the threshold, adding the non-adjacent spatial candidates before the temporal candidates.

52. The method according to clause 49, wherein constructing the candidate merge list based on the POC distance further comprises:

determining whether the POC distance is smaller than a threshold;

in response to the POC being smaller than the threshold, adding the temporal candidates before the non-adjacent spatial candidates and the HMVP candidates; or

in response to the POC being greater than or equal to the threshold, adding the non-adjacent spatial candidates and the HMVP candidates before the temporal candidates.

53. The method according to clause 50, wherein the encoding further comprises:

encoding the threshold at SPS, PPS, picture header, slice header, coding tree unit (CTU), or coding unit level.

54. The method according to clause 48, wherein adaptively constructing the candidate merge list further comprises:

determining a temporal layer of a current picture; and

constructing the candidate merge list based on the temporal layer.

55. The method according to clause 54, wherein constructing the candidate merge list based on the temporal layer further comprises:

determining whether the temporal layer is smaller than a threshold;

in response to the temporal layer being smaller than the threshold, adding the non-adjacent spatial candidates before the temporal candidates; or

in response to the temporal layer being greater than or equal to the threshold, adding the temporal candidates before the non-adjacent spatial candidates.

56. The method according to clause 55, wherein the encoding further comprises:

encoding the threshold at SPS, PPS, picture header, slice header, coding tree unit (CTU), or coding unit level.

57. The method according to clause 48, wherein adaptively constructing the candidate merge list further comprises:

encoding a flag indicating whether to add temporal candidates before spatial candidates;

in response to the flag being a first value, adding the temporal candidates before the spatial candidates; or

in response to the flag being a second value, adding the spatial candidates before the temporal candidates.

58. The method according to clause 57, wherein the flag is encoded at coding unit level.

59. The method according to clause 48, wherein adaptively constructing a candidate merge list further comprises:

encoding a flag indicating whether to add temporal candidates before non-adjacent spatial candidates;

in response to the flag being a first value, adding the temporal candidates before the spatial candidates; or

in response to the flag being a second value, adding the non-adjacent spatial candidates before the temporal candidates.

60. The method according to clause 59, wherein the flag is encoded at a slice header.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for encoding a video sequence, the method comprising:
receiving a video sequence; and
encoding the video sequence by:
determining whether a collocated block in a collocated picture of a current block has a block vector (BV);
in response to the collocated block having the BV, determining the BV;
determining a motion vector for Temporal Motion Vector Prediction (TMVP) for the current block based on the BV of the collocated block; and
determining a reference index of the TMVP to be a reference index of the collocated picture.

2. The method according to claim 1, wherein determining the motion vector for TMVP for the current block based on the BV of the collocated block further comprises:
using the BV of the collocated block as the motion vector for TMVP for the current block.

3. The method according to claim 1, wherein determining the motion vector for TMVP for the current block based on the BV of the collocated block further comprises:
determining a relative position between the current block and the collocated block; and
using a sum of the BV of the collocated block and the relative position as the motion vector for TMVP for the current block.

4. The method according to claim 1, wherein determining the motion vector for TMVP for the current block based on the BV of the collocated block further comprises:
determining a first relative position between the current block and the collocated block;
determining a second relative position between the collocated block and its collocated coding unit, wherein the collocated coding unit includes the collocated block; and
using a sum of the BV of the collocated block, the first relative position, and the second relative position as the motion vector for TMVP for the current block.

5. The method according to claim 1, wherein in response to the collocated block having the BV, determining the BV further comprises:
in response to the collocated block having the BV, determining whether the collocated block is coded using an Intra Template Matching Prediction (IntraTMP) mode or an Intra Block Copy (IBC) mode; and
in response to the collocated block being coded using the IBC mode, obtaining the BV of the collocated block.

6. The method according to claim 1, wherein the collocated block is coded using an Intra Template Matching Prediction (IntraTMP) mode or an Intra Block Copy (IBC) mode.

7. The method according to claim 1, wherein the current block is coded using at least one of: regular merge mode, Combined Inter and Intra Prediction (CIIP) mode, Bi-directional Motion (BM) mode, Template Matching (TM) mode, Merge Mode with Motion Vector Difference (MMVD) mode, Affine mode, Subblock-based Temporal Motion Vector Prediction (SbTMVP) mode, or Advanced Motion Vector Prediction (AMVP) mode.

8. The method according to claim 1, further comprising:
storing a bitstream that is generated based on the encoding.

9. A method for decoding a bitstream, the method comprising:
receiving a bitstream; and
decoding the bitstream to generate a video sequence, the decoding comprising:
determining whether a collocated block in a collocated picture of a current block has a block vector (BV);
in response to the collocated block having the BV, determining the BV;
determining a motion vector for Temporal Motion Vector Prediction (TMVP) for the current block based on the BV of the collocated block; and
determining a reference index of the TMVP to be a reference index of the collocated picture.

10. The method according to claim 9, wherein determining the motion vector for TMVP for the current block based on the BV of the collocated block further comprises:
using the BV of the collocated block as the motion vector for TMVP for the current block.

11. The method according to claim 9, wherein determining the motion vector for TMVP for the current block based on the BV of the collocated block further comprises:
determining a relative position between the current block and the collocated block; and
using a sum of the BV of the collocated block and the relative position as the motion vector for TMVP for the current block.

12. The method according to claim 9, wherein determining the motion vector for TMVP for the current block based on the BV of the collocated block further comprises:
determining a first relative position between the current block and the collocated block;
determining a second relative position between the collocated block and its collocated coding unit, wherein the collocated coding unit includes the collocated block; and
using a sum of the BV of the collocated block, the first relative position, and the second relative position as the motion vector for TMVP for the current block.

13. The method according to claim 9, wherein in response to the collocated block having the BV, determining the BV further comprises:
in response to the collocated block having the BV, determining whether the collocated block is coded using an Intra Template Matching Prediction (IntraTMP) mode or an Intra Block Copy (IBC) mode; and
in response to the collocated block being coded using the IBC mode, obtaining the BV of the collocated block.

14. The method according to claim 9, wherein the collocated block is coded using an Intra Template Matching Prediction (IntraTMP) mode or an Intra Block Copy (IBC) mode.

15. A method for transmitting a bitstream, the method comprising:
receiving a video sequence;
encoding the video sequence by:
determining whether a collocated block in a collocated picture of a current block has a block vector (BV);
in response to the collocated block having the BV, determining the BV;
determining a motion vector for Temporal Motion Vector Prediction (TMVP) for the current block based on the BV of the collocated block; and
determining a reference index of the TMVP to be a reference index of the collocated picture; and
transmitting a bitstream that is generated based on the encoding.

16. The method according to claim 15, wherein determining the motion vector for TMVP for the current block based on the BV of the collocated block further comprises:
using the BV of the collocated block as the motion vector for TMVP for the current block.

17. The method according to claim 15, wherein determining the motion vector for TMVP for the current block based on the BV of the collocated block further comprises:
determining a relative position between the current block and the collocated block; and
using a sum of the BV of the collocated block and the relative position as the motion vector for TMVP for the current block.

18. The method according to claim 15, wherein determining the motion vector for TMVP for the current block based on the BV of the collocated block further comprises:
determining a first relative position between the current block and the collocated block;
determining a second relative position between the collocated block and its collocated coding unit, wherein the collocated coding unit includes the collocated block; and
using a sum of the BV of the collocated block, the first relative position, and the second relative position as the motion vector for TMVP for the current block.

19. The method according to claim 15, wherein in response to the collocated block having the BV, determining the BV further comprises:
in response to the collocated block having the BV, determining whether the collocated block is coded using an Intra Template Matching Prediction (IntraTMP) mode or an Intra Block Copy (IBC) mode; and
in response to the collocated block being coded using the IBC mode, obtaining the BV of the collocated block.

20. The method according to claim 15, wherein the collocated block is coded using an Intra Template Matching Prediction (IntraTMP) mode or an Intra Block Copy (IBC) mode.
